(19) United States
(12) Patent Application Publication
(10) Pub. No.: US 2026/0310135 A1
(43) Pub. Date: Oct. 8, 2026

(54) ELECTRONIC TIMEPIECE, DRIVE CONTROL METHOD, AND RECORDING MEDIUM

(71) Applicant: CASIO COMPUTER CO., LTD., Tokyo (JP)

(72) Inventor: Shohei SAKAMOTO, Tokyo (JP)

(21) Appl. No.: 19/636,081

(22) Filed: Apr. 1, 2026

(30) Foreign Application Priority Data
Apr. 2, 2025 (JP) 2025-061079

(51) Int. Cl. G04C 3/14

(52) U.S. Cl. CPC G04C 3/14

(57) ABSTRACT

An electronic timepiece includes: a hand configured to rotate by a unit angle corresponding to a first unit time obtained by dividing 1 second into a number of plurality of times of unit operation; a driver; and a controller. The controller obtains a completion signal, each time a first timer repeatedly counts the first unit time, in response to the completion signal relating to a previous rotational operation having been obtained, the controller outputs a control signal for causing the hand to perform a rotational operation at a timing at which the first timer counts the first unit time, and in response to the completion signal relating to the previous rotational operation not having been obtained at a time of counting of the first unit time, the controller outputs the control signal at a timing at which the completion signal is obtained.

### CROSS-REFERENCE TO RELATED APPLICATION

This application is based upon and claims the benefit of priority from the prior Japanese Patent Application No. 2025-061079, filed on April 2, 2025, the entire contents of which are incorporated herein by reference.

### BACKGROUND OF THE INVENTION

### TECHNICAL FIELD

The present disclosure relates to an electronic timepiece, a drive control method, and a recording medium.

### DESCRIPTION OF RELATED ART

In an electronic timepiece, there is a technique relating to sweep hand movement in which a second hand is operated at intervals shorter than 1 second so as to make a hand movement appear smooth. In the sweep hand movement, since a frequency at which the hand is caused to perform a rotational operation is high, control is important that allows stable operation while preventing power consumption from becoming excessively large. Japanese Unexamined Patent Application Publication No. 2013-122390 discloses a technique relating to an electronic timepiece capable of appropriately achieving both sweep hand movement and step hand movement while reducing power consumption.

### SUMMARY OF THE INVENTION

According to an aspect of the present disclosure, there is provided An electronic timepiece comprising:

a hand configured to rotate by a unit angle corresponding to a first unit time obtained by dividing 1 second into a number of plurality of times of unit operation;

a driver configured to cause the hand to perform a rotational operation; and

a controller configured to control an operation of the driver, wherein

the controller obtains, for each rotational operation of the hand, a completion signal indicating that the rotational operation has been completed,

each time a first timer repeatedly counts the first unit time, in response to the completion signal relating to a previous rotational operation having been obtained, the controller outputs, to the driver, a control signal for causing the hand to perform a rotational operation at a timing at which the first timer counts the first unit time, and

in response to the completion signal relating to the previous rotational operation not having been obtained at a time of counting of the first unit time, the controller outputs the control signal at a timing at which the completion signal is obtained.

Further features of the present invention will become apparent from the following description of exemplary embodiments with reference to the attached drawings.

### BRIEF DESCRIPTION OF DRAWINGS

FIG. 1 is a block diagram illustrating a functional configuration of an electronic timepiece.

FIG. 2A is a diagram for explaining output of a drive pulse.

FIG. 2B is a diagram for explaining output of a drive pulse.

FIG. 3A is a diagram for explaining adjustment of an output timing of a drive pulse.

FIG. 3B is a diagram for explaining adjustment of an output timing of a drive pulse.

FIG. 4 is a diagram for explaining output of a drive pulse.

FIG. 5 is a flowchart illustrating a control procedure of second-synchronization interrupt control processing.

FIG. 6A is a flowchart illustrating a control procedure of interval timer interrupt processing.

FIG. 6B is a flowchart illustrating a control procedure of completion timer interrupt processing.

FIG. 7 is a block diagram illustrating a functional configuration of an electronic timepiece according to another embodiment.

FIG. 8 is a diagram for explaining output of an interrupt signal.

### DETAILED DESCRIPTION

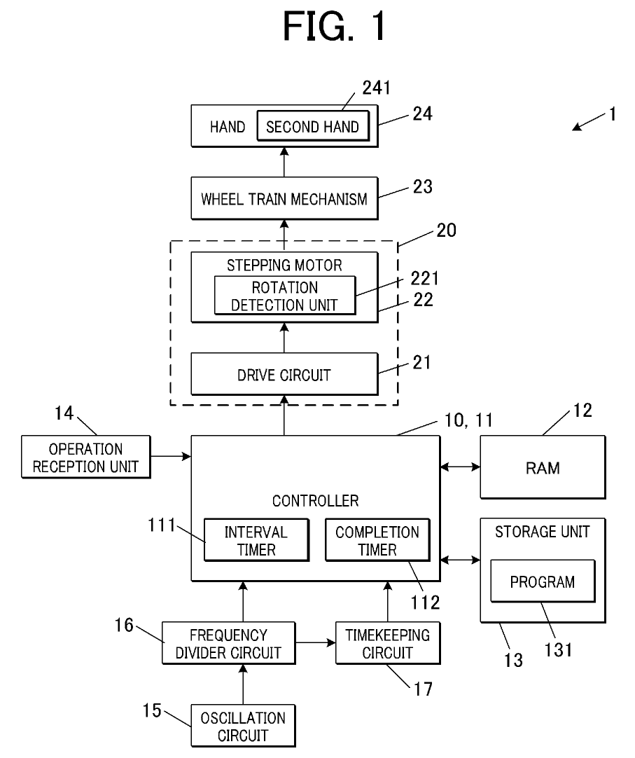

Hereinafter, embodiments will be described with reference to the drawings. As illustrated in the block diagram of FIG. 1, an electronic timepiece 1 includes a controller 11, a RAM 12 (Random Access Memory), a storage unit 13, an operation reception unit 14, an oscillation circuit 15, a frequency divider circuit 16, a timekeeping circuit 17, a drive circuit 21, a stepping motor 22 (motor), a wheel train mechanism 23, a hand 24, and the like. The electronic timepiece 1 may be a portable electronic timepiece, for example, a wristwatch.

The controller 11 includes a processor that controls overall operations of the electronic timepiece 1. The processor may be a general-purpose CPU (Central Processing Unit), or may be a microcontroller dedicated to timepiece operations, an integrated circuit (IC), a large-scale integrated circuit (LSI), or the like. The controller 11 may include a single processor, or may include a plurality of processors to perform processing operations independently of one another in accordance with an intended use and the like. Alternatively, the plurality of processors may cooperate to perform parallel processing. The controller 11 includes an interval timer 111 (first timer) and a completion timer 112 (second timer). The interval timer 111 does not necessarily have a dedicated hardware configuration, and may instead simply calculate an elapsed time by the processor counting a clock signal. The interval timer 111 repeatedly counts a prescribed time from a timing of a second-synchronous signal and outputs a first interrupt signal each time. Generation of the first interrupt signal is also referred to below as a timer interrupt. The completion timer 112 counts a maximum hand-movement time (second unit time) that is a maximum time from an output timing of a drive pulse by the drive circuit 21 to a timing at which output of the drive pulse finally ends. When the completion timer 112 counts the maximum hand-movement time, the completion timer 112 outputs a second interrupt signal as a completion signal indicating that the drive pulse has been completed. Depending on circumstances, output of the drive pulse may end before the completion timer 112 outputs the completion signal. The controller 11 is included in a drive control apparatus 10 of the present embodiment.

The RAM 12 provides the controller 11 with a work memory space and stores temporary data. The RAM 12 stores, for example, hand operation count data per second which is data of the number of times of hand operation per second.

The storage unit 13 includes a nonvolatile memory and stores a program 131 and setting data, and the like. The nonvolatile memory may be, for example, a flash memory. Alternatively, the type of the nonvolatile memory is not particularly limited as long as the nonvolatile memory is usable as another type of nonvolatile memory.

The operation reception unit 14 receives an input operation from outside and outputs, to the controller 11, an operation signal corresponding to a content of the received input operation. The operation reception unit 14 may include, for example, a push-button switch. In addition, the operation reception unit 14 may include a crown, a slide switch, and/or another operation mechanism.

The oscillation circuit 15 includes, for example, a quartz crystal resonator and a resonance circuit, and generates a clock signal near a resonant frequency of the quartz crystal resonator. The resonant frequency may be, for example, 32.768 kHz or 16.384 kHz. The resonant frequency varies depending not only on adjustment accuracy of the quartz crystal resonator but also on environmental conditions such as temperature. The quartz crystal resonator may be an AT-cut type that is stable around room temperature with respect to a temperature change. The frequency divider circuit 16 divides the clock signal into signals having appropriate frequencies and outputs the divided signals. The divided signals may have a plurality of frequencies, and may be defined depending on frequencies required by respective units of the electronic timepiece 1. The divided frequencies may include a 1-Hz signal for counting date and time, that is, a signal having a cycle of 1 second (reference time). The frequency divider circuit 16 may include a logic pacing circuit. With the logic pacing circuit, the 1-Hz signal can be decimated or added as appropriate in accordance with a minute deviation of the 1-Hz signal.

The timekeeping circuit 17 may count the 1-Hz signal to obtain a current time and a date, that is, date and time, in units of 1 second (reference time). An operation of the timekeeping circuit 17 may be included in a software operation of the controller 11. That is, the electronic timepiece 1 does not necessarily include the timekeeping circuit 17 as a hardware configuration. Alternatively, separately from an operation of the controller 11 as the timekeeping circuit 17, the electronic timepiece 1 may include a real-time clock (RTC) as a hardware configuration.

The drive circuit 21 outputs a drive pulse for driving the stepping motor 22 based on control of the controller 11. The stepping motor 22 performs a rotational operation by a prescribed angle in accordance with the input drive pulse. The stepping motor 22 includes a rotation detection unit 221. The wheel train mechanism 23 is a gear train that converts rotation of the stepping motor 22 into rotation of the hand 24. The hand 24 is a needle-like body used for display of time, and performs a rotational operation within a plane along the display surface of the electronic timepiece 1 in accordance with an operation of the wheel train mechanism 23, that is, an operation of the stepping motor 22 in accordance with a control signal from the drive circuit 21. The hand 24 may include a second hand 241, a minute hand, and an hour hand. The hand 24 may include another hand other than the second hand 241, the minute hand, and the hour hand. The other hand may have a rotation axis at a position different from the second hand 241, the minute hand, and the hour hand. The drive circuit 21 and the stepping motor 22 correspond to the driver 20 of the present embodiment.

Next, a rotational operation of the hand 24 relating to the drive control method for the driver 20 in the electronic timepiece 1 of the present embodiment will be described. In the electronic timepiece 1, time is displayed by rotation of the second hand 241, the minute hand, and the hour hand as described above. At least the second hand 241 performs a rotational operation independently of other hands. The second hand 241, the minute hand, and the hour hand may each be independently driven to perform a rotational operation by a respective stepping motor 22 and a respective wheel train mechanism 23. Alternatively, the minute hand and the hour hand may rotate in conjunction with each other. That is, the electronic timepiece 1 may include the wheel train mechanism 23 that rotates the hour hand by a rotation angle of 1/12 of rotation of the minute hand with respect to an operation of a common stepping motor 22.

The second hand 241 of the electronic timepiece 1 performs a rotational operation for each first unit time that is an interval shorter than 1 second and makes one revolution within the display surface in 1 minute. The normal second hand 241 that performs a rotational operation for each 1 second rotates by 6 degrees at one time. In contrast, the second hand 241 of the present embodiment may rotate by an angle obtained by dividing 6 degrees by 12 that is the number of times of unit operation in one rotational operation, that is, by 0.5 degrees. That is, the unit angle by which the second hand 241 rotates in one operation is 0.5 degrees, and the second hand 241 may only need to perform the rotational operation at intervals of approximately 1/12 second. Such a fine rotational operation at substantially equal intervals appears close to smooth rotation in a user’s visual recognition and is also referred to as sweep hand movement. In the present disclosure, the hand that rotates by the unit angle means the second hand 241, but the electronic timepiece 1 may include another hand that operates at intervals shorter than 1 second similarly to the second hand 241. The minute hand and the hour hand may operate as in the conventional manner. For example, the minute hand may perform a rotational operation by 1 degree once every 10 seconds, and the hour hand may perform a rotational operation by 1 degree once every 2 minutes.

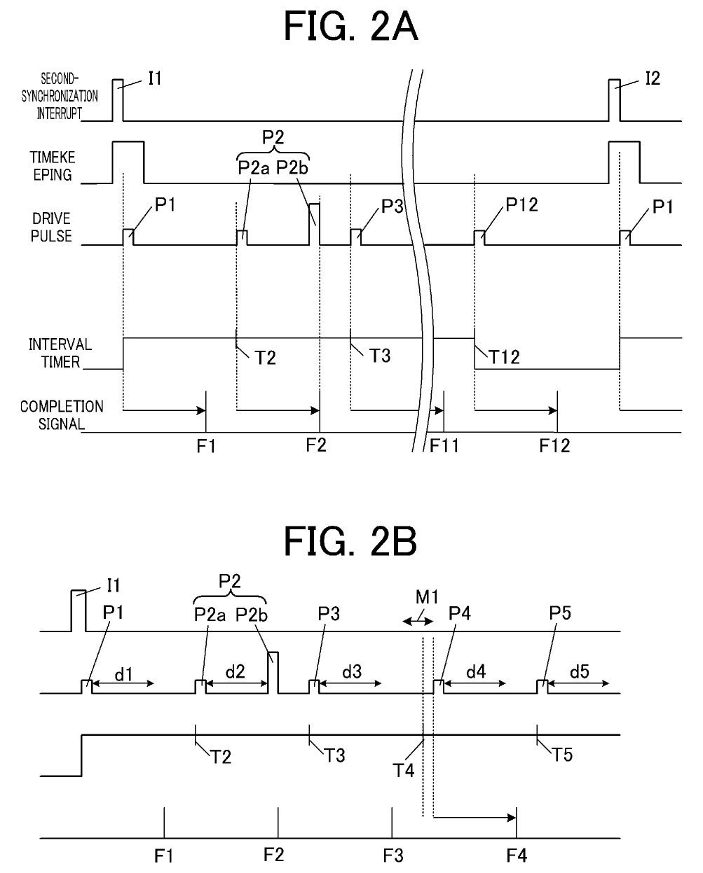

As illustrated in FIG. 2A, in the electronic timepiece 1, a second-synchronous signal synchronized with an on-the-second timing, which is a timing at which a fractional part of each second becomes zero, that is, a start timing of each second, is output to the controller 11 as an interrupt. Hereinafter, this interrupt is also referred to as a second-synchronization interrupt. In response to second-synchronization interrupts I1 and I2, the drive control apparatus 10 performs control to count time and to output a drive pulse for operating a hand as timekeeping processing. The drive pulse is a signal whose duty ratio, which is a ratio of an output time of the drive voltage to an output time of a normal voltage, is appropriately set by PWM (Pulse Width Modulation). The duty ratio may be set within a range in which the stepping motor 22 rotates appropriately as described later. In addition to a drive pulse P1 at second synchronization, the electronic timepiece 1 of the present embodiment defines an output timing of drive pulses P2 to P12 relating to other rotational operations than the second-synchronization timing by repeatedly performing timer measurement of an interval of hand operation, that is, the first unit time, within each second with the second-synchronization interrupt as a reference. Counting of this interval is performed by the interval timer 111. Thus, in the electronic timepiece 1, an output frequency of a synchronization signal with time is not increased in accordance with the number of times of operation of the second hand 241. The interval timer 111 starts counting the first unit time corresponding to each of second-synchronization interrupts I1 and I2 and repeats the counting 11 times, thereby outputting first interrupt signals T2 to T12, respectively. The counting operation of the interval timer 111 ends with output of the first interrupt signal T12.

Here, due to conditions such as reduction of power consumption, it is difficult to accurately count 1/12 second, that is, approximately 83.3 milliseconds, which is an equal interval as an operation interval of the second hand 241. Here, “accurately” means an accuracy in which, when an amount of deviation is accumulated over one day, an amount of time deviation falls within an upper limit value required for a timepiece, for example, within a range of ±0.5 seconds. However, in the electronic timepiece 1, as described above, counting of the interval timer 111 is reset every second by the second-synchronous signal, and thus an error does not accumulate significantly. In addition, a deviation of about 10 to 20 milliseconds in hand operation is hardly visually recognized by a user and does not cause a sense of discomfort. Therefore, counting of 1/12 second may be an approximate calculation. That is, the first unit time counted by the interval timer 111 may have a deviation of, for example, up to about ±1.5 milliseconds relative to 83.3 milliseconds. As a result, an interval between a twelfth drive pulse P12 and a first drive pulse P1 of a next second may increase or decrease somewhat as compared with an interval between other drive pulses.

The drive circuit 21 outputs, to the stepping motor 22, a drive pulse having a predetermined width in accordance with a control signal output from the controller 11 approximately once every 1/12 second, thereby causing the stepping motor 22 to perform a rotational operation. The stepping motor 22 may fail to perform a normal rotational operation due to an influence of an external magnetic field, vibration, or the like. By increasing a duty ratio of the drive pulse to increase an external force applied to a rotor of the stepping motor 22, the stepping motor 22 can be caused to rotate more reliably, but power consumption increases as the duty ratio increases. In the electronic timepiece 1, the drive circuit 21 outputs a first drive pulse at a low duty ratio to an extent that allows the stepping motor 22 to operate stably in a stationary state without external influence on the electronic timepiece 1. Thereafter, whether the stepping motor 22 performs the rotational operation is determined, and, when the stepping motor 22 does not perform the rotational operation, the drive circuit 21 outputs, again, a second drive pulse with an increased duty ratio. The second drive pulse may be a continuous drive pulse having a duty ratio of 100%, that is, in which the drive voltage is continuously output over a pulse width. Thus, when a proportion at which the stepping motor 22 performs the rotational operation normally with the first drive pulse is high, output of the second drive pulse is minimized, and power consumption is reduced. Here, in the drive pulse P2, when it is determined that the stepping motor 22 did not rotate normally with the first drive pulse P2a, the second drive pulse P2b is output again.

In sweep hand movement, it is necessary that a time until an end of output of the second drive pulse P2b is secured within a hand-movement interval. A maximum hand-movement time from a start of output of the first drive pulse P2a to an end of output of the second drive pulse P2b may be, for example, 60 milliseconds. The controller 11 counts, by the completion timer 112 separately, the maximum hand-movement time from output of the first drive pulse. A maximum hand-movement period defines a period during which output of a control signal for a next drive pulse is prohibited. Each time the maximum hand-movement period is counted, the completion timer 112 outputs second interrupt signals F1 to F12.

As illustrated in FIG. 2B, after the first drive pulse P2a and the like are output at a low duty ratio, the drive circuit 21 detects, in periods d1 to d5, whether the rotational operation of the stepping motor 22 has been normally performed. Detection of the rotational operation may be performed based on a detection result of the rotation detection unit 221 included in the stepping motor 22. The rotation detection unit 221 may include, for example, a built-in rotor position detection mechanism or the like. When the rotational operation is not normally performed, a drive pulse having a high duty ratio is re-output promptly.

On the other hand, in the electronic timepiece 1, the controller 11 also performs other operations in addition to the timekeeping processing and operation control of the hand 24. When an operation relating to another function overlaps an operation timing of the hand 24, the operation of the hand 24 may be delayed. Normally, such an operation delay is about several milliseconds, but, depending on details of the operation, a longer processing time than this may be required. In FIG. 2B, as a result of a functional operation M1 overlapping the first interrupt signal T4 of the interval timer 111, output of the drive pulse P4 is delayed relative to the first interrupt signal T4. Accordingly, output of the second interrupt signal F4 is also delayed, but the next drive pulse P5 is output in synchronization with the first interrupt signal T5, whereby a delay amount of the drive pulse P4 is eliminated.

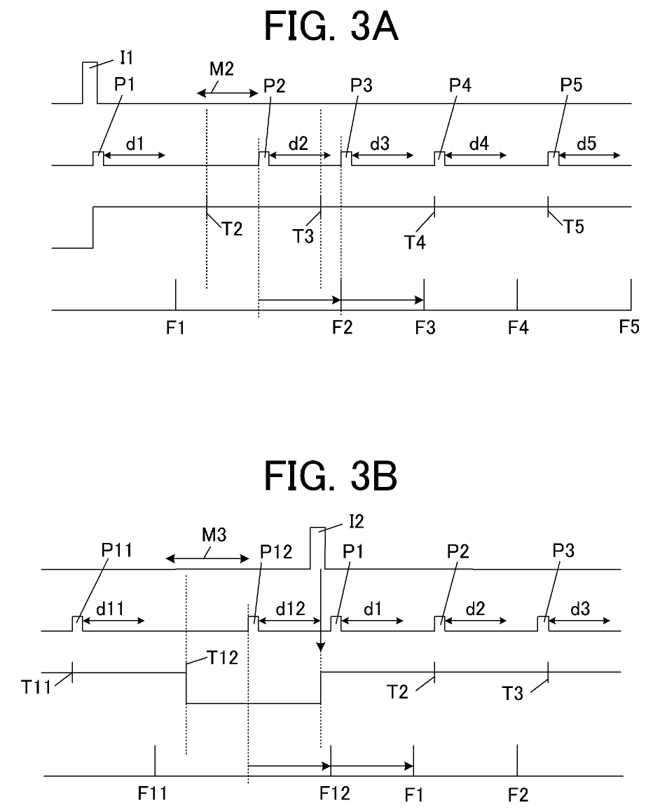

In the example illustrated in FIG. 3A, output of the drive pulse P2 is delayed due to a functional operation M2 that overlaps the first interrupt signal T2. As a result, the second interrupt signal F2 relating to the completion signal accompanying elapse of the maximum hand-movement period is later than the first interrupt signal T3 by the interval timer 111. When the second interrupt signal relating to the completion signal has not been obtained at a timing of the timer interrupt, after both the second interrupt signal F2 of a previous cycle and the first interrupt signal T3 of a current cycle are obtained, a control signal for causing the drive pulse P3 to be output is output to the drive circuit 21. Since the second interrupt signal F3 for the drive pulse P3 has been input to and already obtained by the controller 11 before the first interrupt signal T4, the controller 11 can output, at a timing of the first interrupt signal T4, a control signal for causing the next drive pulse P4 to be output.

As described above, the first interrupt signals T2 to T12 by the interval timer 111 define a fastest output timing of respective drive pulses P2 to P12. The second interrupt signals F1 to F11 corresponding to the maximum hand-movement period are signals that permit output of the next drive pulses P2 to P12 after input of the first interrupt signals T2 to T12. Therefore, when a delay occurs in output of a drive pulse due to another functional operation, the delay time can be reduced, at a maximum, by a difference between a counting time of the interval timer 111 and the maximum hand movement allowable period per one drive pulse.

As illustrated in FIG. 3B, a delay of a drive timing may propagate across a second-synchronization timing. For example, due to a functional operation M3 executed before second synchronization, the second interrupt signal F12 accompanying the maximum hand movement allowable period may not be output at a timing of a hand movement instruction accompanying the second-synchronization interrupt I2. In this case, the drive pulse P1 is output at an output timing of the second interrupt signal F12. Similarly to the above, a minute delay of the drive timing is eliminated while the drive pulse is output several times.

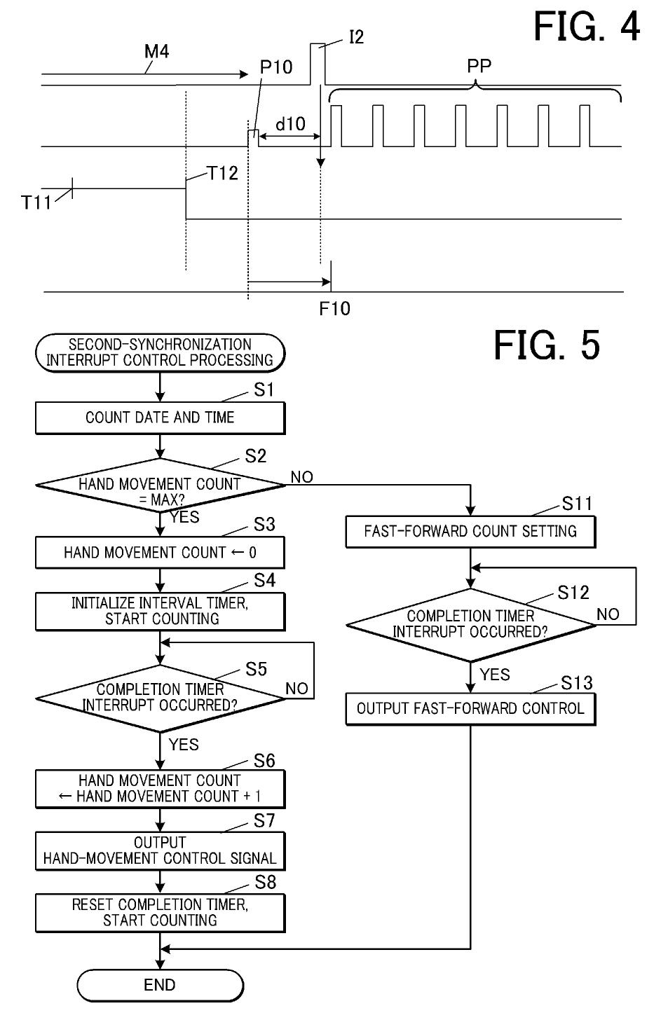

As illustrated in FIG. 4, when an extremely long functional operation M4 is executed, it can be assumed that 12 drive pulses are not output by the second-synchronization interrupt I2. In this case, in the next second, a control signal may be output to the drive circuit 21 to cause the second hand 241 to perform a fast-forward operation for a total number of times of 14, which is a sum of (i) 2 that is the number of times lacking relative to the number of times of unit operation in the previous second, and (ii) 12 that is the number of times of unit operation in the next second. Based on the fast-forward control signal, the drive circuit 21 outputs drive pulses of the total number of times described above as a fast-forward pulse PP. That is, by the fast-forward pulse PP, the second hand 241 is advanced to a hand position at a timing of the next second-synchronization interrupt. The controller 11 waits until the timing of the next second-synchronization interrupt and resumes a hand-movement operation in accordance with the second-synchronization interrupt.

Second-synchronization interrupt control processing executed in the electronic timepiece 1 of the present embodiment is controlled as illustrated in FIG. 5 with the second-synchronization interrupt as a trigger. The controller 11 updates counted date and time (S1). That is, the controller 11 adds 1 second to held current date and time.

The controller 11 determines whether a hand movement count (the number of times of hand movement) is a maximum value MAX (S2). That is, the controller 11 determines whether the second hand 241 has been caused to perform a rotational operation a prescribed number of times, for example, 12 times, in a previous second. When it is determined that the hand movement count is MAX (S2; YES), the controller 11 initializes the hand movement count to zero (S3). The controller 11 initializes the interval timer 111 and starts counting (S4).

The controller 11 determines whether an interrupt by the completion timer 112 has already occurred (S5). When it is determined that the interrupt by the completion timer 112 has not occurred (S5; NO), the controller 11 repeats processing of step S5. When the controller 11 branches to “NO” in step S5, the second-synchronization interrupt control processing may be temporarily ended, and processing relating to another functional operation may be executed.

When it is determined that the interrupt by the completion timer 112 has occurred (S5; YES), the controller 11 adds 1 to the hand movement count (S6). The controller 11 outputs, to the drive circuit 21, a control signal for causing a hand-movement operation to be performed (S7). The controller 11 resets the completion timer 112 to start counting (S8). Then, the controller 11 ends the second-synchronization interrupt control processing.

When it is determined in step S2 that the hand movement count is not MAX (S2; NO), the controller 11 performs a fast-forward setting for a number of times obtained by adding a number of times not performed as hand movement in the previous second and the hand movement count MAX in the current second (S11). The controller 11 determines whether an interrupt by the completion timer 112 has already occurred (S12). When it is determined that the interrupt by the completion timer 112 has not already occurred (S12; NO), the controller 11 repeats processing of step S12. When the controller 11 branches to “NO” in step S12, the controller 11 may temporarily end the second-synchronization interrupt control processing and execute processing relating to another functional operation.

When it is determined that the interrupt by the completion timer 112 has already occurred (S12; YES), the controller 11 outputs, to the drive circuit 21, a control signal for causing fast-forward to be performed (S13). Then, the controller 11 ends the second-synchronization interrupt control processing.

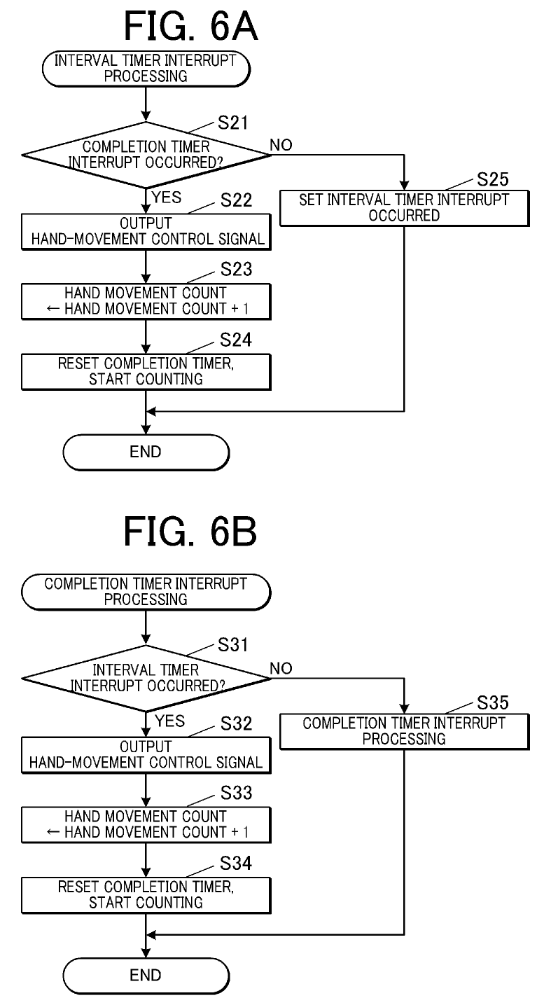

Interval timer interrupt processing that is executed with an interval interrupt generated by the interval timer 111 as a trigger is executed in accordance with a procedure illustrated in FIG. 6A. The controller 11 determines whether an interrupt by the completion timer 112 has already occurred (S21). When it is determined that the interrupt by the completion timer 112 has not already occurred (S21; NO), the controller 11 sets that an interval timer interrupt has already occurred (S25). The setting is performed, for example, by setting a flag or the like. Then, the controller 11 ends the interval timer interrupt processing.

When it is determined that the interrupt by the completion timer 112 has already occurred (S21; YES), the controller 11 outputs, to the drive circuit 21, a control signal for causing hand movement to be performed (S22). The controller 11 adds 1 to the hand movement count (S23). The controller 11 resets the completion timer 112 and causes the completion timer 112 to start counting (S24). Then, the controller 11 ends the interval timer interrupt processing.

Completion timer interrupt processing that is executed with a completion interrupt generated by the completion timer 112 as a trigger is executed in accordance with a procedure illustrated in FIG. 6B. The controller 11 determines whether an interrupt by the interval timer 111 has already occurred (S31). When it is determined that the interrupt by the interval timer 111 has not already occurred (S31; NO), the controller 11 sets that a completion timer interrupt has already occurred (S35). The setting is performed, for example, by setting a flag or the like. Then, the controller 11 ends the completion timer interrupt processing.

When it is determined that the interrupt by the interval timer 111 has already occurred (S31; YES), the controller 11 outputs, to the drive circuit 21, a control signal for causing hand movement to be performed (S32). The controller 11 adds 1 to the hand movement count (S33). The controller 11 resets the completion timer 112 and causes the completion timer 112 to start counting (S34). Then, the controller 11 ends the completion timer interrupt processing.

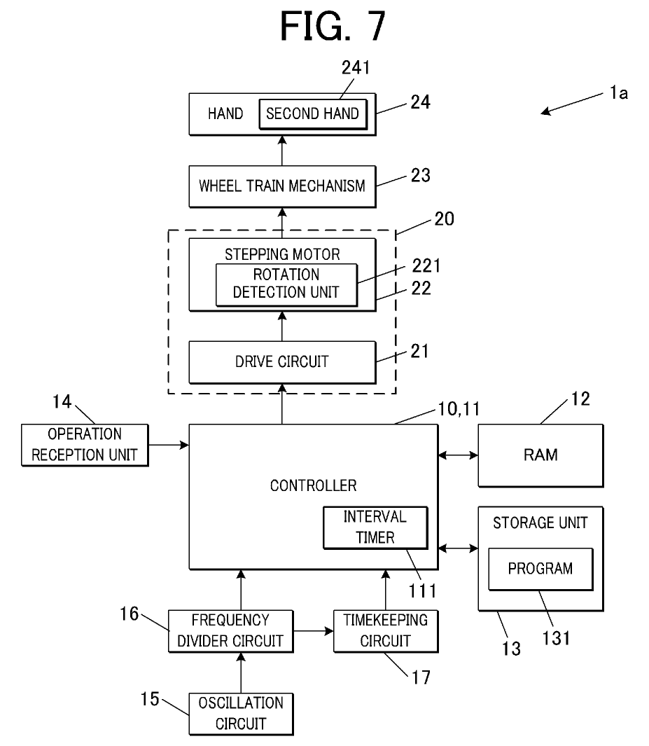

As illustrated in FIG. 7, in an electronic timepiece 1a of an embodiment, the controller 11 may obtain a hand movement completion signal from the drive circuit 21 based on a detection result of the rotation detection unit 221 included in the stepping motor 22, without having the completion timer 112. The drive circuit 21 may output the hand movement completion signal to the controller 11 when rotation by a low duty ratio drive pulse is detected in the stepping motor 22 or when output of a high duty ratio drive pulse has been completed.

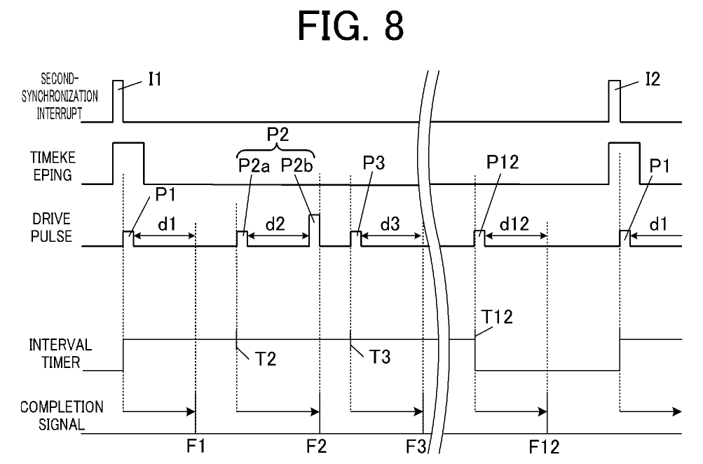

In this case, as illustrated in FIG. 8, when the rotational operation of the stepping motor 22 by the low duty ratio drive pulse is detected, the hand movement completion signal is output in a shorter time than the maximum hand movement allowable time described above. Second interrupt signals F1, F3, and F12 indicating ends of drive pulses P1, P3, and P12 may be immediately after rotor rotation detection periods d1, d3, and d12 in the stepping motor 22. A timing at which output of the high duty ratio drive pulse is completed may be a timing at which a waiting time for stabilization described above elapses after a voltage of a substantially rectangular wave that is the drive pulse returns to a normal voltage. That is, the second interrupt signal F2 indicating an end of output of the drive pulse P2 may be the same as an end timing of the maximum hand movement allowable period described above. In addition, even when the hand movement completion signal is based on detection of the rotational operation of the stepping motor 22, the hand movement completion signal may be unified and output at least at a timing at which the maximum hand movement allowable period elapses, similarly to the above.

In this embodiment, processing contents of respective interrupt signals related to control of hand movement are the same as the second-synchronization interrupt control processing, the interval timer interrupt processing, and the completion timer interrupt processing described above, and thus description thereof will be omitted.

As described above, the drive control apparatus 10 of the present embodiment includes the controller 11. The controller 11 controls an operation of the driver 20 that causes the second hand 241 to perform a rotational operation by 0.5 degrees, which is a unit angle corresponding to a first unit time obtained by dividing 1 second into a plurality of number of times of unit operation, which is 12 here, that is, approximately 1/12 second. For each rotational operation of the second hand 241, the controller 11 obtains second interrupt signals F1 to F12 indicating that the rotational operation has been completed. Each time the interval timer 111 counts the first unit time, when the second interrupt signals F1 to F12 corresponding to a control signal of a previous cycle have already been obtained, the controller 11 outputs, to the driver 20, a control signal for driving the second hand 241 at a timing at which the interval timer 111 counts the first unit time and the first interrupt signals T1 to T12 occur. When the second interrupt signals F1 to F12 of the previous cycle have not been obtained when the first unit time is counted and the first interrupt signals T1 to T12 occur, the controller 11 outputs a control signal for rotating the second hand 241 at a timing at which the second interrupt signals F1 to F12 are obtained. According to the electronic timepiece disclosed in Japanese Unexamined Patent Application Publication No. 2013-122390 described above, there are other processes executed in addition to hand movement processing, and the hand movement processing may be delayed by the other processes, and, when such delays accumulate and affect beyond each second, the hand movement processing becomes complicated and stable operation becomes difficult to maintain. However, in the drive control apparatus 10 of the present disclosure and the electronic timepiece 1 including the drive control apparatus 10, in sweep hand movement, a delay can be eliminated while maintaining a minimum interval required for operation of the second hand 241 by a combination of the interval timer 111 and counting of the maximum hand-movement time that is shorter than the first unit time period. Therefore, the drive control apparatus 10 and the electronic timepiece 1 can execute sweep hand movement more stably with simple processing.

The controller 11 may obtain a second-synchronous signal that defines a start timing of each second. The controller 11 may start counting by the interval timer 111 in accordance with the second-synchronous signal and count the first unit time repeatedly by the number of times of unit operation. As described above, since counting by the interval timer 111 is reset at the second-synchronization timing every second, an error does not accumulate even when counting accuracy of the interval timer 111 is not as high as counting accuracy of time. Since counting accuracy of the interval timer 111 is not required as compared with counting of time, the drive control apparatus 10 and the electronic timepiece 1 can reduce labor and cost required for generation of a clock signal and the like.

When the controller 11 has not output the control signal for the number of times of unit operation by a timing at which the second-synchronous signal is input, the controller 11 may output, to the driver 20, a fast-forward control signal for causing a fast-forward operation for a total number of times that is a sum of (i) the number of times of control signals lacking relative to the number of times of unit operation and (ii) the number of times of unit operation. In addition, since a large delay of one or more steps in operation of the second hand 241 is not accumulated over a plurality of seconds and is promptly eliminated by fast-forward, the drive control apparatus 10 and the electronic timepiece 1 can reduce labor of carrying over delay information across seconds.

The controller 11 may count, from an operation timing of the driver 20, a maximum hand-movement time preset as a maximum time required for the rotational operation of the second hand 241, and may obtain second interrupt signals F1 to F12 indicating completion from the completion timer 112 that outputs the second interrupt signals F1 to F12 at a timing at which the maximum hand-movement time is counted. By uniformly defining and counting the maximum hand-movement time mechanically, it is possible to easily define another hand movement prohibited period without considering increase or decrease of an actual hand-movement operation. Therefore, the drive control apparatus 10 and the electronic timepiece 1 can stably reduce the delay every second without difficulty even when the rotational operation of the second hand 241 is delayed.

The driver 20 may include the stepping motor 22 configured to cause the second hand 241 to perform the rotational operation and the drive circuit 21 configured to output a drive pulse for operating the stepping motor 22 in accordance with the control signal. After outputting a first drive pulse in accordance with the control signal, the drive circuit 21 determines whether the stepping motor 22 operates. When the stepping motor 22 does not operate, the drive circuit 21 may output a second drive pulse that applies a greater external force to the stepping motor 22 than the first drive pulse. The maximum hand-movement time may be a time from a start of output of the first drive pulse to an end of output of the second drive pulse in a case where the second drive pulse is output. As described above, while power consumption is reduced by output of the drive pulse in two stages, depending on an operating state of the stepping motor 22 with the low duty ratio drive pulse, a time required for the operation may be extended. Nevertheless, the time of the hand-movement operation is not so large as compared with the first unit time. Therefore, in the drive control apparatus 10, labor of processing may be reduced by uniformly counting a time including the second drive pulse as the maximum hand-movement time.

The electronic timepiece 1 of the present embodiment includes the second hand 241, the driver 20 configured to cause the second hand 241 to perform a rotational operation, and the drive control apparatus 10 described above. According to the electronic timepiece 1, the second hand 241 can be caused to perform sweep hand movement appropriately, and, even when a delay occurs in the operation, the delay can be recovered relatively easily while avoiding an unnatural display to a certain extent without affecting timekeeping operation. Therefore, the electronic timepiece 1 can execute sweep hand movement more stably with simple processing.

The drive control method for the driver 20 of the present embodiment includes the following steps. (1) obtains a second interrupt signal corresponding to a completion signal indicating, for each rotational operation of the second hand 241, that the rotational operation has been completed. (2) each time the interval timer 111 counts the first unit time, when the second interrupt signal relating to the completion signal for a previous rotational operation has already been obtained, outputting, to the driver 20, a control signal for driving the second hand 241 at a timing at which the interval timer 111 counts the first unit time and the first interrupt signal occurs. (3) when the second interrupt signal relating to the completion signal for the previous rotational operation has not been obtained when the first unit time is counted and the first interrupt signal occurs, outputting the control signal at a timing at which the second interrupt signal relating to the completion signal is obtained. With such drive control, it is possible to eliminate a delay of hand movement simply and easily while reducing an unnatural operation, and to perform stable sweep hand movement.

The contents described in the above embodiment are examples, and various modifications are possible. For example, although counting by the interval timer 111 is reset every 1 second in the above, the reset does not necessarily have to be performed once per second. The reset may be performed every plurality of seconds within a range in which a cumulative deviation of a counting time of the interval timer 111 does not become non-negligible. In this case, for a second-synchronous signal for which the reset is not performed, only timekeeping processing may be performed. For example, when the number of times of unit operation is a power of two such as 8, counting accuracy of the interval timer 111 can be more easily increased than for 10 times and 12 times, and thus an interval of the reset may be widened.

In the above, a case has been permitted in which the maximum hand-movement time relating to a twelfth drive pulse crosses the second-synchronization timing, but such a case does not necessarily have to be permitted. A drive pulse may be started by about 60 milliseconds before second synchronization based on counting by the interval timer 111, and, when a drive pulse for the number of times of unit operation has not been output by that timing, the drive pulse may be subject to fast-forward control in the next second. Thus, a situation in which a hand-movement operation at a synchronization timing of the next second is delayed is avoided.

Counting by the interval timer 111 and/or the completion timer 112 is not limited to an operation performed by the controller 11 by software control. The counting may be performed by an external configuration, and the external configuration may be a hardware timer, for example, a flip-flop circuit.

In the above, it has been described that a waveform of the drive pulse is controlled by PWM, but the waveform is not limited thereto. For example, a pulse width of a continuous drive pulse may be changed. In addition, a duty ratio of the first drive pulse may be changed and set in accordance with an output frequency of the second drive pulse and the like. In particular, when the output frequency of the second drive pulse is high, a change setting to increase the duty ratio of the first drive pulse may be performed.

In the above, sweep hand movement of the second hand 241 has been described as an example, but a target whose rotational operation is controlled by the above drive control may be other than the second hand 241, for example, a hand that indicates 1/10 second. In addition, a rotation angle per second does not necessarily have to be 6 degrees.

A setting indicating that a completion timer interrupt has already occurred may be set by default. Thus, when hand movement starts initially or when hand movement resumes from stoppage, hand movement can be started or resumed without causing a problem.

In the above, hand movement of the electronic timepiece 1 has been described as an example, but any electronic device may be used as long as the electronic device counts and displays time or a period. A display target may be elapsed time or the like instead of time of day.

In the above description, the storage unit 13 including a nonvolatile memory such as a flash memory has been described as an example of a computer-readable medium that stores the program 131 relating to operation control of the driver 20 of the present disclosure, but the computer-readable medium is not limited thereto. As another computer-readable medium, it is possible to apply another nonvolatile memory such as MRAM, or a portable storage medium such as a CD-ROM or a DVD disc. In addition, as a medium that provides program data according to the present disclosure via a communication line, a carrier wave is also applicable. In addition, specific configurations, contents and procedures of processing operations, and the like shown in the above embodiment can be appropriately changed without departing from the spirit of the present disclosure. The scope of the present disclosure includes the scope of inventions described in the claims and equivalents thereof.

1. An electronic timepiece comprising:
a hand configured to rotate by a unit angle corresponding to a first unit time obtained by dividing 1 second into a number of plurality of times of unit operation;
a driver configured to cause the hand to perform a rotational operation; and
a controller configured to control an operation of the driver, wherein
the controller obtains, for each rotational operation of the hand, a completion signal indicating that the rotational operation has been completed,
each time a first timer repeatedly counts the first unit time, in response to the completion signal relating to a previous rotational operation having been obtained, the controller outputs, to the driver, a control signal for causing the hand to perform a rotational operation at a timing at which the first timer counts the first unit time, and
in response to the completion signal relating to the previous rotational operation not having been obtained at a time of counting of the first unit time, the controller outputs the control signal at a timing at which the completion signal is obtained.

2. The electronic timepiece according to claim 1, wherein the controller obtains a synchronization signal that defines a start timing of each second, starts counting by the first timer in accordance with the synchronization signal, and counts the first unit time repeatedly for the number of times of unit operation.

3. The electronic timepiece according to claim 2, wherein, in response to the control signal not having been output for the number of times of unit operation by a timing at which the synchronization signal is input, the controller outputs, to the driver, a fast-forward control signal for causing a fast-forward operation for a total number of times that is a sum of a number of times of the control signal lacking relative to the number of times of unit operation and the number of times of unit operation.

4. The electronic timepiece according to claim 1, wherein the controller obtains the completion signal from a second timer configured to count a second unit time preset as a maximum time required for the rotational operation of the hand from an operation timing of the driver and output the completion signal at a timing at which the second unit time is counted.

5. The electronic timepiece according to claim 4, wherein the driver includes a motor configured to cause the hand to perform the rotational operation and a drive circuit configured to output a drive pulse for operating the motor in accordance with the control signal,
after outputting a first drive pulse in accordance with the control signal, the drive circuit determines whether the motor operates, and, in response to the motor not operating, the drive circuit outputs a second drive pulse that applies an external force to the motor, the external force being greater than a force applied by the first drive pulse, and
the second unit time is a time from a start of output of the first drive pulse to an end of output of the second drive pulse in a case where the second drive pulse is output.

6. A drive control method for controlling an operation of a driver of an electronic timepiece that includes a hand configured to rotate by a unit angle corresponding to a first unit time obtained by dividing 1 second into a number of plurality of times of unit operation and the driver configured to cause the hand to perform a rotational operation, the drive control method comprising:
obtaining, for each rotational operation of the hand, a completion signal indicating that the rotational operation has been completed;
each time a first timer repeatedly counts the first unit time, in response to the completion signal relating to a previous rotational operation having been obtained, outputting, to the driver, a control signal for causing the hand to perform a rotational operation at a timing at which the first timer counts the first unit time; and
in response to the completion signal relating to the previous rotational operation not having been obtained at a time of counting of the first unit time, outputting the control signal at a timing at which the completion signal is obtained.

7. The drive control method according to claim 6, comprising obtaining a synchronization signal that defines a start timing of each second, starting counting by the first timer in accordance with the synchronization signal, and counting the first unit time repeatedly for the number of times of unit operation.

8. The drive control method according to claim 7, comprising in response to the control signal not having been output for the number of times of unit operation by a timing at which the synchronization signal is input, outputting, to the driver, a fast-forward control signal for causing a fast-forward operation for a total number of times that is a sum of a number of times of the control signal lacking relative to the number of times of unit operation and the number of times of unit operation.

9. The drive control method according to claim 6, comprising obtaining the completion signal from a second timer configured to count a second unit time preset as a maximum time required for the rotational operation of the hand from an operation timing of the driver and output the completion signal at a timing at which the second unit time is counted.

10. The drive control method according to claim 9, wherein
the driver includes a motor configured to cause the hand to perform the rotational operation and a drive circuit configured to output a drive pulse for operating the motor in accordance with the control signal,
after outputting a first drive pulse in accordance with the control signal, the drive circuit determines whether the motor operates, and, in response to the motor not operating, the drive circuit outputs a second drive pulse that applies an external force to the motor, the external force being greater than a force applied by the first drive pulse, and
the second unit time is a time from a start of output of the first drive pulse to an end of output of the second drive pulse in a case where the second drive pulse is output.

11. A non-transitory computer-readable recording medium storing a program for a computer included in an electronic timepiece that includes a hand configured to rotate by a unit angle corresponding to a first unit time obtained by dividing 1 second into a number of plurality of times of unit operation and a driver configured to cause the hand to perform a rotational operation, the program causing the computer to execute:
obtaining, for each rotational operation of the hand, a completion signal indicating that the rotational operation has been completed;
each time a first timer repeatedly counts the first unit time, in response to the completion signal relating to a previous rotational operation having been obtained, outputting, to the driver, a control signal for causing the hand to perform a rotational operation at a timing at which the first timer counts the first unit time; and
in response to the completion signal relating to the previous rotational operation not having been obtained at a time of counting of the first unit time, outputting the control signal at a timing at which the completion signal is obtained.

12. The recording medium according to claim 11, wherein the program causes the computer to further execute
obtaining a synchronization signal that defines a start timing of each second, starting counting by the first timer in accordance with the synchronization signal, and counting the first unit time repeatedly for the number of times of unit operation.

13. The recording medium according to claim 12, wherein the program causes the computer to further execute
in response to the control signal not having been output for the number of times of unit operation by a timing at which the synchronization signal is input, outputting, to the driver, a fast-forward control signal for causing a fast-forward operation for a total number of times that is a sum of a number of times of the control signal lacking relative to the number of times of unit operation and the number of times of unit operation.

14. The recording medium according to claim 11, wherein the program causes the computer to further execute
obtaining the completion signal from a second timer configured to count a second unit time preset as a maximum time required for the rotational operation of the hand from an operation timing of the driver and output the completion signal at a timing at which the second unit time is counted.

15. The recording medium according to claim 14, wherein
the driver includes a motor configured to cause the hand to perform the rotational operation and a drive circuit configured to output a drive pulse for operating the motor in accordance with the control signal,
after outputting a first drive pulse in accordance with the control signal, the drive circuit determines whether the motor operates, and, in response to the motor not operating, the drive circuit outputs a second drive pulse that applies an external force to the motor, the external force being greater than a force applied by the first drive pulse, and
the second unit time is a time from a start of output of the first drive pulse to an end of output of the second drive pulse in a case where the second drive pulse is output.
